(19) United States
(12) Patent Application Publication
(10) Pub. No.: US 2009/0243841 A1
(43) Pub. Date: Oct. 1, 2009

(54) COGNITIVE MONITORING WIRELESS DEVICE FOR HEALTHCARE EQUIPMENT

(75) Inventor: Yasser H. Alsafadi, Yorktown Heights, NY (US)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N. V., Eindhoven (NL)

(21) Appl. No.: 12/302,987

(22) PCT Filed: May 24, 2007
(86) PCT No.: PCT/US2007/069598

§ 371 Date: Dec. 1, 2008

Related U.S. Application Data
(60) Provisional application No. 60/803,739, filed on Jun. 2, 2006.

(51) Int. Cl. G08B 1/08

(52) U.S. Cl. 340/539.22

(57) ABSTRACT

A cognitive monitoring wireless apparatus (10, 10′) includes a cognitive monitor (12) and a cognitive radio (14). The cognitive monitor receives inputs from a plurality of sensors (32-40, 90, 92) and decides based on the sensed inputs which messages should be forwarded. The cognitive radio receives the messages to be forwarded from the cognitive monitor, selects among available communication formats, and wirelessly communicates the messages. The communication parameters include frequency, maximum allowed power, code, and protocol. The apparatus monitors the hardware and software of healthcare equipment and communicates intelligent information about the condition of the equipment.

The present application relates to wireless monitoring devices for healthcare equipment. It finds particular application for monitoring healthcare equipment, such as wireless medical sensors, diagnostic imaging systems, and the like. However, it is to be appreciated that this application is also applicable to monitoring other equipment including industrial equipment, manufacturing equipment, transportation equipment, residential and commercial building equipment, military equipment, and the like.

Healthcare equipment typically has numerous mechanical and electrical systems that can fail. Failure of these systems can render the equipment inoperative until it is repaired, leaving healthcare professionals unexpectedly without an important diagnostic or treatment tool. As one example, a CT scanner typically includes a rotating gantry which rotates on bearings which need maintenance, has power supplies for the x-ray tube, computer and other electronic equipment, cooling systems, a movable patient support, and the like, all of which may need maintenance or replacement. A CT scanner can have an automatic diagnostic system which monitors various conditions, such as arcing of the x-ray tube. When the arcing becomes too frequent, this information can be communicated to a central facility over a dedicated telephone line. Other conditions such as overheating bearings, processor malfunctions, and the like are similarly reportable.

All diagnostic equipment is not readily amenable to dedicated telephone lines. For example, a mobile ultrasound system can move from location to location. Transmitting monitored information from mobile equipment to a central station can be done in various ways, such as with a dedicated radio frequency signal. However, such mobile equipment may be operated in a variety of environments, such as a temperature controlled hospital in which thousands of electronic devices such as cell phones, PDAs, computers, healthcare monitors, and the like are all communicating wirelessly. Other times, the portable ultrasound system might be located in other environments, such as a field hospital in a dry hot desert, in a cool, damp mountain clinic, or the like.

Some healthcare equipment, such as patient worn physiological condition monitors, freely move among different sites in different environments and with different access to radio communications. Moreover, radio frequency bands are typically allocated on a national or regional basis. This requires such monitors to be manufactured specifically for each country. When the patient travels to another country, the communication frequency might be allocated for a different purpose, such as television or radio, which would strongly interfere with signals from the patient worn sensor.

Similar problems occur in other types of large stationary equipment, such as the machinery of a manufacturing facility, other types of mobile equipment such as automobiles, locomotives, and the like, and others.

The present application proposes a cognitive monitoring wireless device which overcomes the above-referenced problems and others.

In accordance with one aspect, a cognitive monitoring wireless apparatus is provided. A cognitive monitor is adapted to receive inputs from a plurality of sensors, generate messages indicative of at least some of the inputs received from the sensors, and decide, based on the sensed inputs, which messages should be forwarded. The apparatus further includes a cognitive radio which receives the messages from the cognitive monitor, selects among available communication parameters, and wirelessly communicates the messages.

In accordance with another aspect, a method of cognitive monitoring is provided. Inputs are received from a plurality of sensors. The messages indicative of at least some of the inputs received from the sensors are generated. Which of the messages should be forwarded is decided based on the sensed inputs. A selection among available communication parameters is made and the messages are wirelessly communicated.

One advantage is that it readily adapts to different types of healthcare and other equipment.

Another advantage is that it readily adapts to different environments.

Another advantage resides in reducing unpredicted downtime.

Still further advantages of the present invention will be appreciated to those of ordinary skill in the art upon reading and understand the following detailed description.

The invention may take form in various components and arrangements of components, and in various steps and arrangements of steps. The drawings are only for purposes of illustrating the preferred embodiments and are not to be construed as limiting the invention.

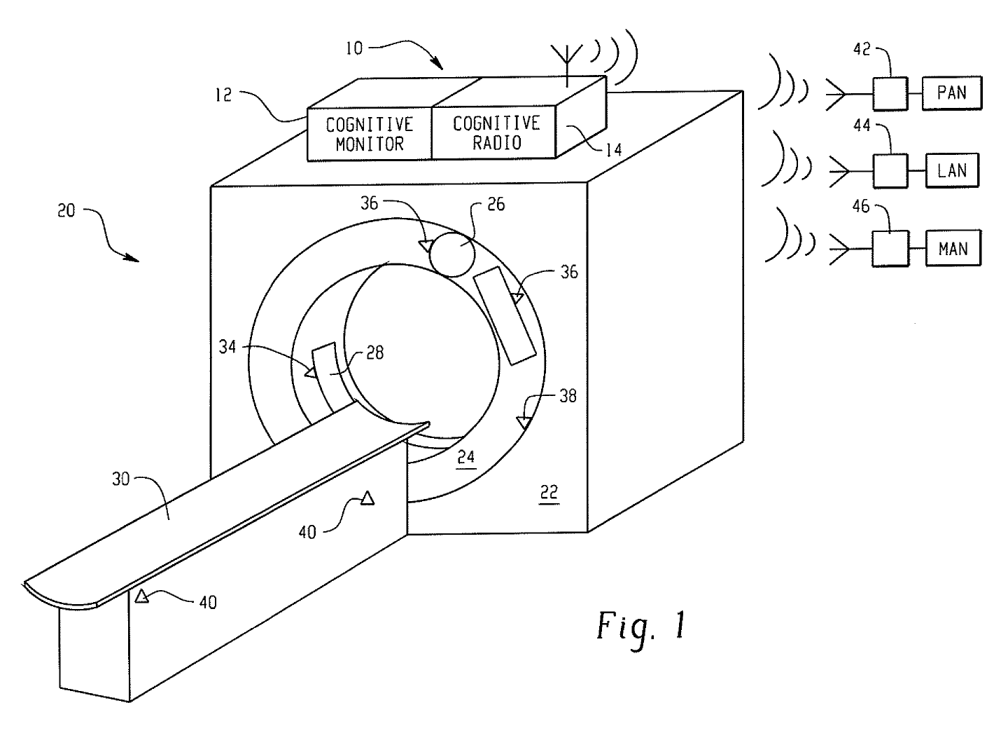

FIG. 1 is a diagrammatic view of a cognitive monitoring system;

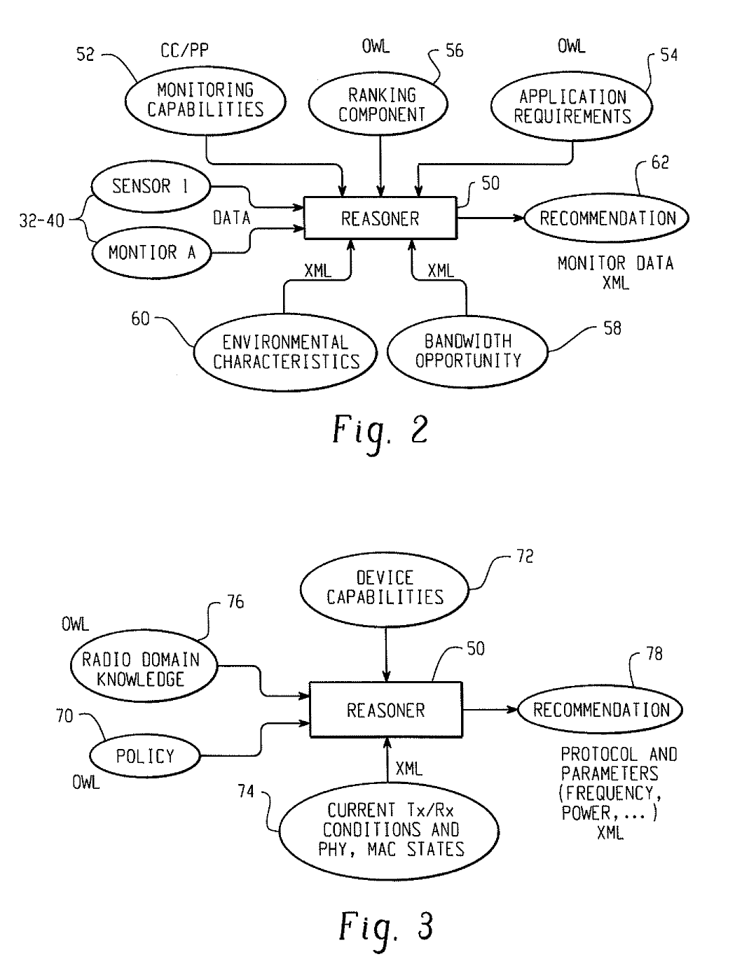

FIG. 2 is a diagrammatic illustration of a decision support system for the cognitive monitor of FIG. 1;

FIG. 3 is a simplified implementation of a decision support system for the cognitive radio of FIG. 1;

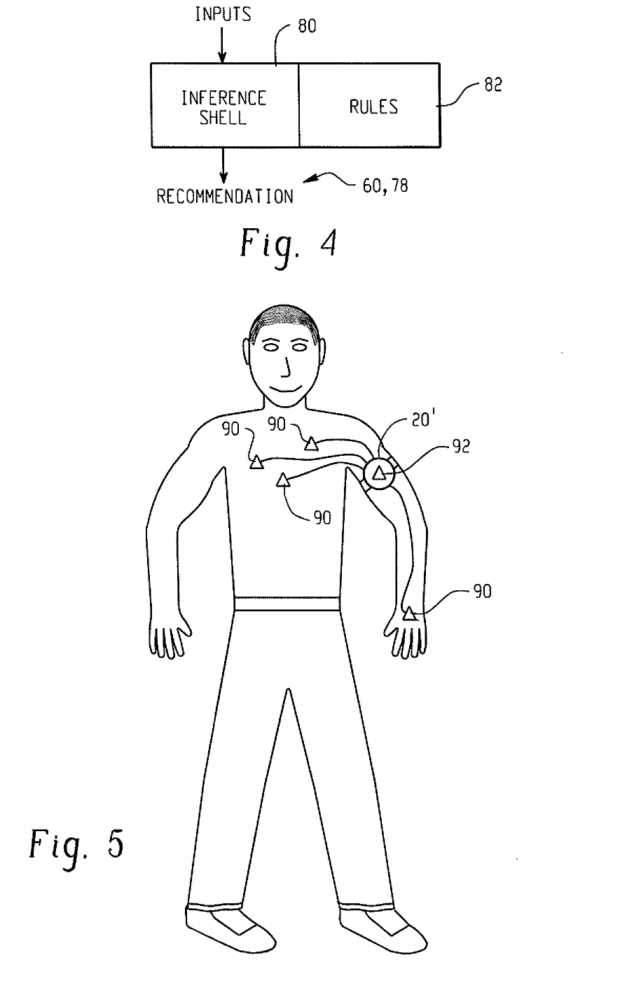

FIG. 4 is a diagrammatic representation of components of the reasoner of FIGS. 2 and 3; and

FIG. 5 illustrates an alternate embodiment in which the cognitive monitor is incorporated in a physiological condition monitor.

Machine and system condition monitoring is of vital importance to modern industry in its quest for high reliability, quality and efficiency. High costs in maintaining today's complex and sophisticated equipment create a need to enhance modern maintenance management systems. Condition-based maintenance (CBM) reduces the uncertainty of maintenance according to the needs indicated by the equipment condition. For example, online continuous monitoring enables the health of a plant to be continuously updated. Machinery can be shut down if a serious defect threatens an imminent catastrophic failure. Other, less urgent defects can be monitored and scheduled for repair at the next maintenance shutdown. Planning maintenance in advance enables spare parts to be ordered and all necessary manpower and resources to be available for the periodic maintenance, minimizing the downtime.

The growth of wireless services over the past several years demonstrates the vast and growing demand of businesses, customers, and governments for spectrum-based communication links. Spectrum access, efficiency, and reliability, are critical public policy issues. Advances in technology are creating the potential for radio systems to use more spectrum more intensely and with more efficiency than ever before. Among these advances are cognitive radio technologies that make possible more intensive and efficient spectrum uses by licensees within their own networks and by spectrum users sharing spectrum access on a negotiated or opportunistic basis. These technologies include, among other things, the ability of devices to determine their location, sense a spectrum in use by neighboring devices, change frequency, adjust power, and even alter transmission parameters and characteristics. These radio technologies open spectrum for use in space, time, and frequency dimensions that have previously been unavailable.

With reference to FIG. 1, a cognitive device 10 gathers input from any of a variety of monitored devices, selects which monitored data should be communicated, and selects which mode of wireless communication to use. The cognitive device 10 includes a cognitive monitor 12 and a cognitive radio 14. The cognitive monitor is an intelligent system that decides which monitored information should be communicated. This involves understanding the monitoring parameters, the equipment's condition, and the environment. The cognitive radio 14 is a radio that can change its transmitter parameters based on an interaction with the environment in which it operates. This interaction may involve active negotiation or communications with other spectrum users and/or passive sensing and decision making within the cognitive radio.

In the exemplary embodiment of FIG. 1, the cognitive monitor is connected with a CT scanner 20. The scanner includes a stationary gantry 22 and a rotating gantry 24. An x-ray tube 26, detectors 28, and various other computers, cooling systems, coolant pumps, and the like are also mounted on the rotating gantry. The rotating gantry is supported on the stationary gantry by one or more bearings. A patient support 30 includes motors and gears for adjusting its height and for advancing the top into and out of the bore of the CT scanner. A plurality of sensors, such as a sensor 32 which senses arcing or other intermittent problems with the x-ray tube 26, a monitor 34 for monitoring malfunctions of the x-ray detector, and other sensors 36 sense operation of the electronic equipment, the power supply, circulation of the coolant, coolant temperature, and the like. Additional sensors 38 on the stationary gantry monitor bearing temperature, the operation of electronic equipment on the stationary gantry, and the like. Additional monitors 40 on the patient support monitor operation of the motors and gears. The monitors 38 and 40 on the stationary gantry and the patient support communicate the sensed information to the cognitive monitor by wires. The sensors 32, 34, 36 on the rotating gantry can communicate their sensed information to the cognitive monitor via a slip ring, by RF communications, by optical communications, or the like. Of course, the CT scanner is illustrated by way of example only. Numerous other types of healthcare and non-healthcare equipment can also be outfitted with one or more sensors. Equipment is understood also to include small pieces of equipment, such as a patient-worn portable physiological condition monitor.

After collecting the data, the cognitive monitor 12 analyzes the ensemble of signals, using any of various techniques such as a logical alarm reduction algorithm (LARA) to identify erroneous or artifact signals versus true information signals. That is, the cognitive monitor sorts these signals according to their quality with artifacted signals being ranked low in quality versus artifact-free signals. The cognitive radio 14 selects the transmission protocol in accordance with the spectrum opportunities available. It may transmit to a receiver 42 of a personal area network (PAN), a receiver 44 of a local area network (LAN), a receiver 46 of a metropolitan area network (MAN), or the like.

With reference to FIG. 2, the cognitive monitor 12 includes a reasoner or logic processor 50. The reasoner is connected with the plurality of sensors or monitors, such as sensors 32-40 discussed above, which input data collected from the monitored devices. The exact characteristics of the monitored and sensed data will vary in accordance with the sensors or monitors and may advantageously be described using composite capability/preference profile (CC/PP) structure and vocabulary in accordance with the W3C recommendation. With a generic cognitive monitor which is amenable to receiving different types of inputs, the monitoring capabilities 52 are input by an operator during initial set-up.

The reasoner further receives application requirements 54 describing the relationships among different monitored or sensed data. The requirements may include a set of rules regarding which data to communicate to the central location under which circumstances. For example, when sensing the temperature of the bearing, the application requirements will include a set of rules regarding how hot the bearing can get and at what temperatures information should be sent. For example, if the bearing is running 10% above normal, the rules may call for this information to be collected, summarized, and transmitted only daily or weekly. However, if the bearing temperature is escalating rapidly approaching a critical potential failure temperature, then the rules may call for the sensed temperatures to be communicated more frequently. The exact frequency may depend on the rate of temperature increase. When the bearing reaches the critical imminent failure temperature, the rules may call for that information to be sent immediately. Various other rules which describe the characteristics of the various sensed data which should be sent and the priority with which it should be sent are also contemplated. A ranking component 56 identifies erroneous signals or artifacts and helps differentiate the artifacts from artifact-free signals and ranks them accordingly. Artifact-free signals are ranked the highest and heavily artifacted signals are ranked the lowest. A bandwidth opportunity input 58 from the cognitive radio 14 advises the reasoner 50 of the amount of bandwidth available. The bandwidth opportunity information can, for example, be expressed in XML. Typically, the rules will specify that when there is very limited bandwidth available, only the highest priority information will be transmitted. By distinction, when a significant amount of bandwidth is available, lower priority information may be sent. In one embodiment, the various requirements are expressed in ontology web language (OWL).

The rules may specify different priorities when the equipment is operating under different environmental conditions. An environmental characteristics input 60 inputs information about the current usage environment. It captures appropriate information about location, time, temperature, humidity other environmental factors, the nature of the location such as hone, office, factory, battle field, and the like. Information about rural versus city may also be input. Appropriate environmental condition sensors and inputs as may be appropriate to the significant environmental characteristics are connected with the one or more environmental characteristic inputs 60. Inputs can be transmitted from a defined source or can be localized with the monitoring apparatus.

The reasoner 50 utilizes the ranking provided by the ranking component, the available bandwidth provided by the cognitive radio, the application requirements and other inputs in order to apply the rules in a logical analysis to generate a recommendation 62 regarding which input data or messages are to be transmitted. The rules utilized by the reasoner can be dynamic based on information or parameters from other sources.

The cognitive radio 14 selects the bandwidth opportunity which the cognitive monitor can use. With reference to FIG. 3, an exemplary decision support system for the cognitive radio includes a policy description input 70 which describes constraints on transmission parameters to limit the level of interference received by primary radio systems in the area close to the secondary radio system. In the United States, the policy is prescribed by the Federal Communications Commission (FCC) and is represented in the OWL language using ontologies. A device capabilities input 72 receives a description of the characteristics and limitations of the device, such as its source of electrical power, CPU, memory, frequency range, channelization, modulation encoding scheme, and communication protocols. This can be described using the CC/PP recommendation.

A current transmit/receive conditions input 74 provides feedback about the condition of the current transmission environment, e.g., noisy, low chatter, etc. Measurement results are defined by various accepted standards, such as IEEE 802.11h, IEEE 802.11k, or the like, and may be described as ontology using the OWL language. A radio domain knowledge input 76 links to a repository of knowledge about the domain of radio communications. This includes such information as may be required about transmission parameters by algorithms for spectrum opportunity management. For example, transmission power, frequency, maximum distances between communicating devices, the modulation encoding schemes, and the like are related to each other. For example, the reasoner 50 may want to know if the device increases the transmission power, the detection range increases, and at the same time the level of interference that other radio devices would observe increases. There are many more interdependencies among the different radio transmission parameters. This base of information facilitates the generation of appropriate rules for the information, environment, the needed radio transmission distances, and the like which may be available.

Using the rules and these parameters, the reasoner 50 makes a logical decision and generates a further recommendation 78 that describes the parameters for transmission such as the frequency, the maximum allowed power, code, a particular protocol, and the like. The recommendation may, for example, be represented as an XML document or string.

With reference to FIG. 4, the reasoner component 50 can be implemented as an inference engine to derive the parameter recommendations based on inferences from previous inputs. The reasoner can identify several spectrum opportunities based on information from the policies, the current transmit/receive condition feedback, and device capabilities.

The cognitive radio is preferably a spectrum agile device. The rules utilized by the reasoner 50 are representations of the algorithms employed by such a spectrum agile device. These can be modeled using Protégé, for example. A rule engine, such as JESS, in a Java environment is used as an inference engine or shell 80.

The described device provides a platform which the user can tailor or program to any of a multitude of equipment types by appropriate loading the rules and other inputs into a rules memory 82. The rules are dynamic, rather than static. That is, the rules are updated and changed as sensors, industry and government standards, technology, and the like change or are updated. These devices can be deployed anywhere in the world including in different markets with different available spectrums and will still be able to communicate alarms. Custom tailored mobile security or environmental monitoring systems can be created with intelligent alarms that are always in communication with authorities. Such a device reports useful information about the condition of any subsystem, system, major component, and the like, any time from any place by detecting the spectrum opportunities and establishing a wireless communication link.

With reference to FIG. 5, the cognitive monitor 12 is housed in a physiological condition monitor 20′. Sensors 90, such as EKG, pulse rate, blood oxygen, and other sensors input sensed information into the portable monitor 20′ and the cognitive device 10. Additional sensors 92 for sensing battery levels and potential malfunctions or maintenance indicators in the monitor 20′ are connected with the cognitive monitor 12 to input signals indicative of the sensed conditions. As described above, the cognitive monitor decides, based on various rules and inputs, which of the received sensor inputs should be transmitted to a central location and with what priority.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A cognitive monitoring wireless apparatus comprising:
a cognitive monitor which is adapted to receive inputs from a plurality of sensors, generate messages indicative of at least some of the inputs received from the sensors, and decide based on the sensed inputs which of the messages should be forwarded;
a cognitive radio which receives the messages from the cognitive monitor, selects among available communication parameters, and wirelessly communicates the messages.

2. The apparatus according to claim 1, further including a plurality of sensors connected with a healthcare apparatus for sensing operating conditions, the sensors being connected to the cognitive monitor.

3. The apparatus according to claim 1, wherein the cognitive monitor includes:
a reasoner which performs a logical analysis of the input from the sensors based on rules and other available information.

4. The apparatus according to claim 3, wherein the cognitive monitor further includes at least one of:
a monitoring capabilities input which receives characteristics of the input from the sensors and the sensors for use in the logic analysis;
an application requirements input which receives a description of relationships among different potential inputs for use in the logical analysis;
a ranking component input which provides data for determining a degree of artifacting of the inputs received from the sensors and ranking the inputs accordingly;
a bandwidth opportunity input which receives characteristics of available bandwidth from the cognitive radio for use in the logical analysis; and,
an environmental characteristics input which receives data describing a current usage environment for use in the logical analysis.

5. The apparatus according to claim 4, wherein the logical analysis performed by the reasoner uses the ranking provided by the ranking component input, the available bandwidth provided by the bandwidth opportunity input from the cognitive radio, the application requirements provided by the application requirements input, and other inputs to determine which messages should be transmitted.

6. The apparatus according to claim 3, wherein the reasoner makes logical decisions concerning transmission properties of the cognitive radio, the reasoner further including at least one of:
a policy description input which receives regulatory constraints on transmission parameters for use in making the logical decisions;
a device capabilities input which receives input describing characteristics and limitations of the cognitive radio for use in the logical decision making;
a current transmit/receive conditions input which receives data describing a current transmission environment experienced by the cognitive radio;
a radio domain knowledge input which receives algorithms for spectrum opportunity management.

7. The apparatus according to claim 6, wherein the logical decision making performed by the reasoner generates a recommendation which describes the radio frequency transmission parameters to be used by the cognitive radio.

8. The apparatus according to claim 7, wherein the transmission parameters include frequency, maximum allowed power, code, and protocol.

9. The apparatus according to claim 2, wherein the healthcare device is one of an imager and a portable patient carried physiological condition monitor.

10. The apparatus according to claim 1, further including a plurality of sensors which are adapted to be affixed to a patient to measure physiological conditions, the sensors being connected with the cognitive monitor.

11. The apparatus according to claim 1, wherein the cognitive monitor includes an inference engine and a memory which stores a plurality of rules received from rules inputs, the inference engine analyzing the received inputs from the sensors in accordance with the rules to decide which information should be sent to a remote monitoring station.

12. A cognitive monitoring method comprising:
receiving inputs from a plurality of sensors;
generating one or more messages indicative of at least some of the inputs received from the sensors, deciding based on the sensed inputs which of the messages should be forwarded;
selecting among available communication parameters; and,
wirelessly communicating the messages to be forwarded.

13. The method according to claim 12, wherein selecting among available communication parameters includes selecting among frequency, maximum allowed power, code, and protocol.

14. The method according to claim 12, further including:
with the sensors, sensing operating conditions of a healthcare apparatus.

15. The method as set forth in claim 12, further including:
performing a logical analysis on the inputs from the sensors based on at least one of:
monitoring capabilities which describe characteristics of the input from the sensors and the sensors;
application requirements which describe relationships among different potential inputs;
ranking data from which a degree of artifacts in the received inputs from the sensors can be determined and the inputs ranked;
bandwidth opportunity which describes characteristics of available bandwidth for wirelessly communicating the messages; and,
environmental characteristics which describe a current usage environment.

16. The method according to claim 12, further including:
making logical decisions concerning communication parameters based on at least one of:
policy description which describes regulatory constraints on transmission parameters;
device capabilities describing characteristics and limitations of a cognitive radio which selects the communication format and wirelessly communicates the messages;
current transmit/receive conditions which describe a current transmission environment experienced by the cognitive radio;
radio domain knowledge which includes algorithms for spectrum opportunity management.

17. The method according to claim 12, wherein the steps of deciding which messages should be forwarded and selecting among available communication formats includes operating on rules received when a plurality of rules input with an inference engine to analyze the received inputs from the sensors in accordance with the rules inputs.

18. A monitoring device comprising:
an apparatus for determining one or more messages to be sent based on one or more input parameters;
an apparatus for determining one or more transmit parameters based on the location of the monitoring device; and
an apparatus for transmitting the determined messages.

19. The monitoring device according to claim 18 wherein the messages sent are based on a set of rules.

20. The monitoring device according to claim 19 wherein the rules are dynamic.
